(19) United States
(12) Patent Application Publication
(10) Pub. No.: US 2008/0133507 A1
(43) Pub. Date: Jun. 5, 2008

(54) System and Method for Providing Aircraft Owner and Operator Information

(76) Inventors: Renee Alter, Stamford, CT (US); James Cole, East Setauket, NY (US); Matt Marcella, West Hempstead, NY (US)

Correspondence Address: FAY KAPLUN & MARCIN, LLP, 150 BROADWAY, SUITE 702, NEW YORK, NY, 10038, US

(21) Appl. No.: 11/931,798

(22) Filed: Oct. 31, 2007

Related U.S. Application Data
(60) Provisional application No. 60/855,673, filed on Oct. 31, 2006.

(51) Int. Cl. G06F 17/30

(52) U.S. Cl. 707/5; 340/945; 707/E17.017

(57) ABSTRACT

A system and method for receiving information relating to an aircraft, correlating the information to owner/operator information of the aircraft and outputting the owner/operator information to a user. Also, a system having a database storing owner/operator information for a plurality of aircraft and a processor receiving flight tracking information for a first aircraft of the plurality of aircraft, the processor retrieving the owner/operator information for the first aircraft from the database based on the flight tracking information and outputting the flight tracking information and the owner/operator information for the first aircraft.

### PRIORITY CLAIM/INCORPORATION BY REFERENCE

This application claims the benefit of U.S. Provisional Patent Application 60/855,673, filed on Oct. 31, 2006, and entitled “System and Method for Providing Aircraft Owner and Operator Information,” which is expressly incorporated herein, in its entirety, by reference.

### FIELD OF THE INVENTION

The present invention relates generally to systems and methods for obtaining owner and operator information for aircraft and providing that information to a user.

### BACKGROUND

There are numerous existing hardware and/or software systems that allow users to track aircraft in various manners. Such systems may display aircraft information including graphical display of flight tracks and/or corresponding text displays. Such systems may obtain data in a variety of manners; in one example, the system collects or receives passive radar data and creates flight tracks for each aircraft that is within the current tracking range.

However, existing systems fail to allow a user to obtain and view owner/operator information about aircraft that are being tracked while the flight track or textual data about the aircraft are being displayed in real time. Aircraft owner/operator information may be useful to users of a live aircraft tracking system for a variety of purposes.

### SUMMARY OF THE INVENTION

A system and method for receiving information relating to an aircraft, correlating the information to owner/operator information of the aircraft and outputting the owner/operator information to a user.

Also, a system having a database storing owner/operator information for a plurality of aircraft and a processor receiving flight tracking information for a first aircraft of the plurality of aircraft, the processor retrieving the owner/operator information for the first aircraft from the database based on the flight tracking information and outputting the flight tracking information and the owner/operator information for the first aircraft.

### BRIEF DESCRIPTION OF THE DRAWINGS

FIG. 1 shows a exemplary system for providing aircraft owner/operator data according to the present invention.

FIG. 2 shows an exemplary method for obtaining aircraft owner/operator data and providing it to a user of a live aircraft tracking system according to the present invention.

FIG. 3 shows a first exemplary screen showing owner/operator information for tracked aircraft that may be displayed to a user of the system of FIG. 1.

FIG. 4 shows a second exemplary screen showing owner/operator information for tracked aircraft that may be displayed to a user of the system of FIG. 1.

### DETAILED DESCRIPTION

The exemplary embodiments of the present invention may be further understood with reference to the following description and the appended drawings, wherein like elements are referred to with the same reference numerals. The exemplary embodiments of the present invention describe systems and methods to improve the usefulness of systems for tracking aircraft. Using the exemplary embodiments, owner/operator data for aircraft that are being tracked may be retrieved and provided to a user.

As used in this disclosure, an “aircraft” may be any vehicle capable of air travel. For example, an aircraft may be a fixed wing aircraft (e.g., large or small passenger aircraft, recreational aircraft, etc.), a rotorcraft, an unpowered aircraft (e.g., a sailplane), a dirigible, etc.

Aircraft tracking systems may provide a wide variety of information to users. In addition to positional data (which may be expressed graphically or textually, and may include, for example, latitude and longitude information, altitude, heading, airspeed, etc.), tracking systems may provide information about the manufacturer and model of the aircraft, which may be useful for determining the speed and maneuverability capabilities of the aircraft. Information provided may also include fuel usage rate and fuel remaining, which may help determine priority order for landing aircraft. Further, information provided may include flight plan data for aircraft that are being tracked, which may help determine proper routing of multiple aircraft.

One type of useful information that is not provided to users of existing systems is owner/operator data for aircraft that are being tracked. A user of a live aircraft tracking system may wish to be able to obtain owner/operator data in order to establish communications with a ground representative of an airline, properly route an arriving aircraft to a gate, hangar or fueling location, determine priority for landing, or for various other reasons.

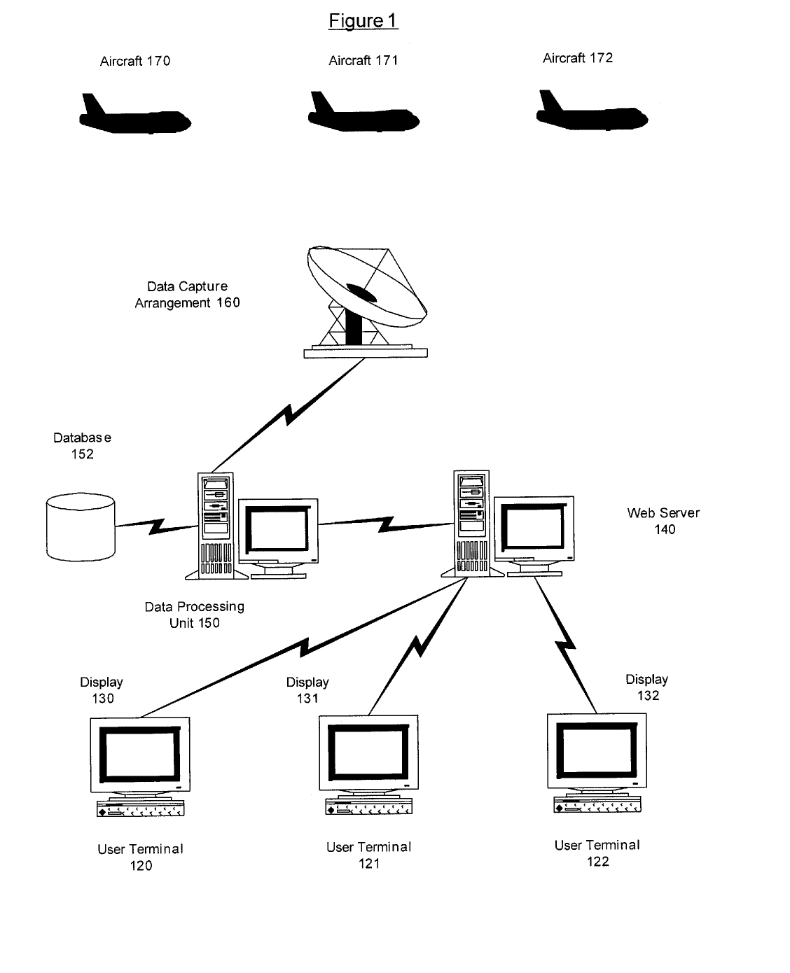

FIG. 1 shows an exemplary embodiment of a system 100 according to the present invention. The system 100 may include one or more user terminals 120, 121, 122 by which a user may access the system 100. The user terminals 120, 121, 122 may be, for example, computer network workstations. The user terminals 120, 121, 122 may typically include at least a display 130, 131, 132. For the sake of clarity, the exemplary embodiments will be described specifically with reference to the user terminal 120 and its corresponding display 130; however, those of skill in the art will understand that the other user terminals and displays may operate in the same manner.

The user terminal 120 may be connected to a data network 110, which may be, for example, a local area network, a wide area network, etc. Via the data network 110, the user terminal 120 may communicate with a web server 140. The web server 140 may receive requests for content from the user terminal 120 and transmit resulting data back to the user terminal 120 in a format that is viewable by a user on the display 130. The web server 140 may also be in communication with a data processing unit 150, which may typically be a network data server. The data processing unit 150 may communicate with database 152, which may contain owner/operator information for a plurality of aircraft.

The database 152 may be received in its completed form, such as during installation of the software that operates the data processing unit 150. Alternately, the database 152 may be populated during operation of the system. For example, information concerning flight plans may be retrieved. The flight plans may identify, for example, a tail number for a plurality of aircraft 170, 171, 172. In another example, tail number information may be determined from the aircraft, e.g., using active or passive radars, etc. The tail number information may then be used to find the owner/operator information for the aircraft and populated into the database 152. The database 152 may be integral to the data processing unit 150 or it may be a separate item located locally or remotely.

The data processing unit 150 may communicate with a data capture arrangement 160, which may include one or more Passive Secondary Surveillance Radar (“PSSR”) systems. A PSSR system may be, for example, the PASSUR® system sold by Megadata Corporation of Greenwich, Conn. Data collected by the data capture arrangement 160 may include, but is not limited to, a location of arriving aircraft. Those skilled in the art will understand that the exemplary embodiments are described with reference to a PSSR system. However, the present invention is not limited to collecting location data using a PSSR system. The data capture arrangement 160 may be any system that collects, directly or indirectly, data about aircraft 170, 171, 172. This disclosure will proceed by describing the method as performed to obtain information regarding aircraft 170, but those of skill in the art will understand that the same exemplary system and method are equally applicable to any selected aircraft.

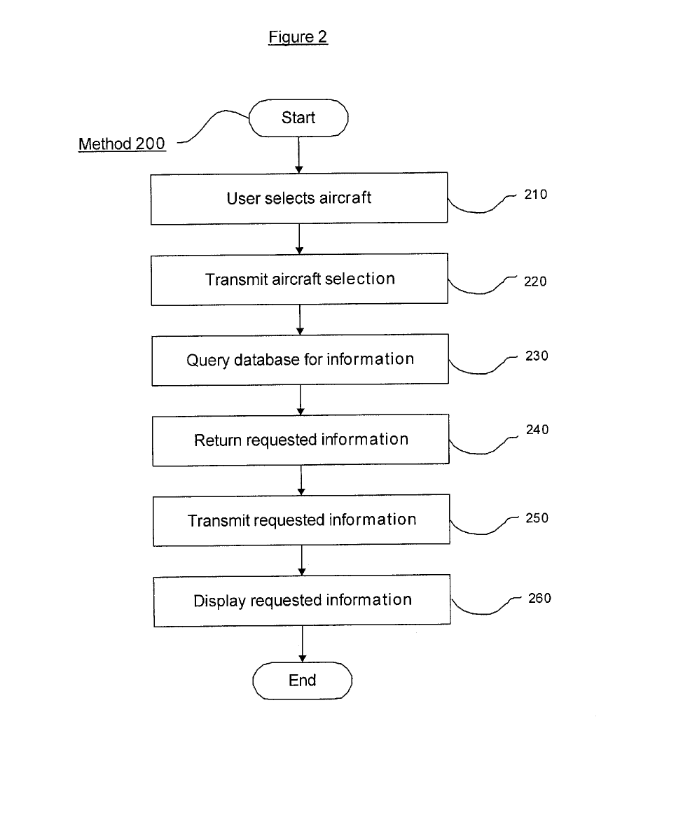

FIG. 2 shows an exemplary embodiment of a method 200 according to the present invention. The method 200 will be described with reference to the exemplary system 100 of FIG. 1; however, those of skill in the art will understand that the exemplary method 200 may also be applied by systems that vary from the one described above. In step 210, a user of the terminal 120 selects an aircraft 170 from a group of aircraft 170, 171, 172 that are being tracked. In step 220, the identity of the selected aircraft 170 is transmitted from the user terminal 120 to the web server 140 via the network 110, and subsequently is transmitted from the web server 140 to the data processing unit 150. The aircraft 170 may typically be identified by its tail number, but may also be identified by any other unique identifier suitable for this purpose.

In step 230, the data processing unit 150 queries the database 152 with the identity of the selected aircraft 170. In step 240, the database 152 returns owner/operator information about the aircraft 170 to the data processing unit 150. Returned information may be the name of the owner of aircraft 170, the operator of aircraft 170, the pilot of aircraft 170, or any other such information pertaining to an individual or business entity associated with the aircraft 170. In step 250, the owner/operator information is transmitted from the data processing unit 150 to the user terminal 120 via the web server 140. In step 260, the owner/operator information is displayed to a user of the user terminal 120 on the display 130. In some exemplary embodiments, the owner/operator information may be displayed on its own; in other embodiments, the owner/operator information may be displayed together with other relevant information about the aircraft 170.

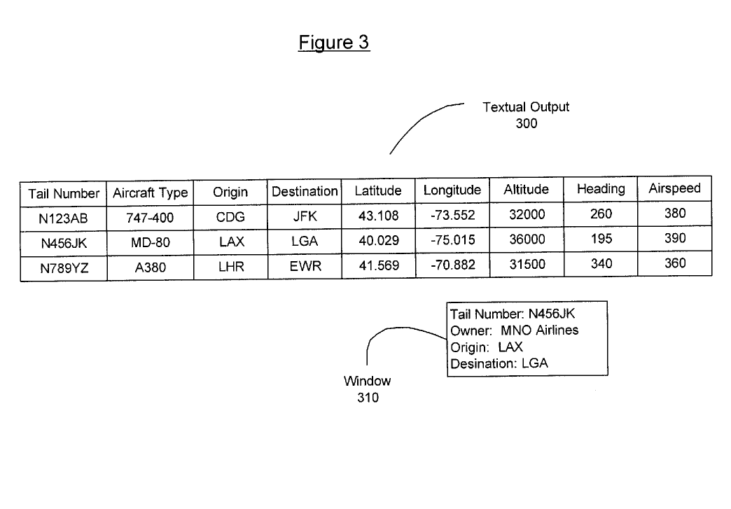

FIG. 3 shows an exemplary output on display 130 for an exemplary system 100 wherein the user of the user terminal 120 is tracking aircraft using a textual output 300. To commence operation of the exemplary method 200, the user may select the aircraft 170 (e.g., by mousing over or clicking on the display line for aircraft 170 with a mouse, etc.). When the method 200 has executed, the owner/operator information may be displayed to the user, such as by the appearance of a window 310 containing the retrieved information.

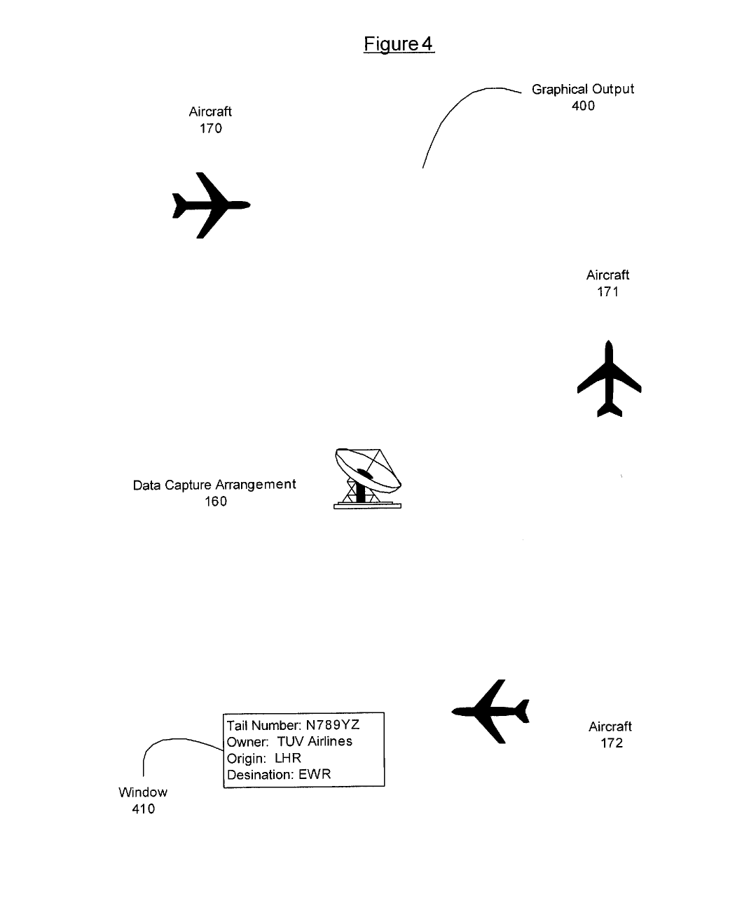

FIG. 4 shows an exemplary output on display 130 for an exemplary system 100 wherein the user of the user terminal 120 is tracking aircraft using a graphical output 400 representing positions of the aircraft 170, 171 and 172 relative to that of the data capture arrangement 160. Those of skill in the art will understand that in other embodiments, the positions of the aircraft may be represented relative to that of one or more airports, a ground map, or any other reference suitable to inform a user of the positions of the displayed aircraft, and that the use of the data capture arrangement 160 as a reference point is only exemplary. To commence operation of the exemplary method 200, the user may select the aircraft 172 (e.g., by mousing over or clicking on the icon representing the aircraft 172, etc.). When the method 200 has executed, the owner/operator information may be displayed to the user, such as by the appearance of a window 410 containing the retrieved information.

The exemplary embodiments of the present invention provide improved access to information for the user of an aircraft tracking system. Owner/operator information is made available intuitively, through an existing interface, and with minimal user effort.

The present invention has been described with reference to the above specific exemplary embodiments. However, those of ordinary skill in the art will recognize that the same principles may be applied to other embodiments of the present invention, and that the exemplary embodiments should therefore be read in an illustrative, rather than limiting, sense.

What is claimed is:

1. A method, comprising:
receiving information relating to an aircraft;
correlating the information to owner/operator information of the aircraft; and
outputting the owner/operator information to a user.

2. The method of claim 1, wherein the information is flight tracking information.

3. The method of claim 1, wherein the correlating is based on a tail number of the aircraft.

4. The method of claim 2, wherein the owner/operator information is output as one of a textual display and a graphical display with the flight tracking information.

5. The method of claim 1, further comprising:
receiving a request from the user for the owner/operator information.

6. The method of claim 1, wherein the correlating includes:
receiving flight plan information for the aircraft.

7. The method of claim 1, wherein the information is received from one of a passive radar data feed, an active radar data feed and a multilateration radar data feed.

8. A system, comprising:
a database storing owner/operator information for a plurality of aircraft; and
a processor receiving flight tracking information for a first aircraft of the plurality of aircraft, the processor retrieving the owner/operator information for the first aircraft from the database based on the flight tracking information and outputting the flight tracking information and the owner/operator information for the first aircraft.

9. The system of claim 8, wherein the processor formats the flight tracking information and the owner/operator information as one of textual information and graphical information.

10. The system of claim 8, wherein the flight tracking information includes tail number information for the first aircraft, the owner/operator information being retrieved based on the tail number information.

11. The system of claim 8, wherein the processor outputs the flight tracking information and the owner/operator information for the first aircraft in response to a received user input.

12. The system of claim 8, wherein the database is populated based on a correlation between owner/operator information and a tail number in a flight plan.

13. The system of claim 8, wherein the flight tracking information is received from one of a passive radar data feed, an active radar data feed and a multilateration radar data feed.

14. The system of claim 8, wherein the flight tracking information includes one of an aircraft type, an origin of the first aircraft, a destination of the first aircraft, a latitude location of the first aircraft, a longitude location of the first aircraft, an altitude of the first aircraft, a heading of the first aircraft and an airspeed of the first aircraft.

15. A system comprising a memory storing a set of instructions and a processor executing the instructions, the instructions being operable to:
receive information relating to an aircraft;
correlate the information to owner/operator information of the aircraft; and
output the owner/operator information to a user.
